(19) United States
(12) Patent Application Publication
(10) Pub. No.: US 2022/0129840 A1
(43) Pub. Date: Apr. 28, 2022

(54) System And Method For Reinforcement-Learning Based On-Loading Optimization

(71) Applicant: Genpact Luxembourg S.à r.l, Luxembourg (LU)

(72) Inventors: Kajal Negi, Kashirampur Talla (IN); Mohit Makkar, Gurgaon (IN); Yogita Rani, Punjab (IN); Rajeev Ranjan, Bangalore (IN); Chirag Jain, Bangalore (IN); Sreekanth Menon, Bangalore (IN); Shishir Shekhar, Bangalore (IN)

(21) Appl. No.: 17/080,612

(22) Filed: Oct. 26, 2020

(51) Int. Cl. G06Q 10/08; G06N 3/08; G01C 21/34; G06K 9/62

(52) U.S. Cl. CPC G06Q 10/0832; G06Q 10/0833; G06Q 10/087; G06K 9/6256; G01C 21/3484; G06K 9/6267; G06N 3/08

(57) ABSTRACT

A method and system are provided where a module employing reinforcement learning (RL) can learn to solve the vehicle selection and space allocation problems for the transportation and/or storage of goods. In one embodiment, a method includes: (a) obtaining a specification of a load that includes enclosures of one or more enclosure types, and the specification includes, for each enclosure type: (i) dimensions of an enclosure of the enclosure type, and (ii) a number of enclosures of the enclosure type. The method also includes (b) obtaining a specification of vehicles of one or more vehicle types, where the specification includes, for each vehicle type: (i) dimensions of space available within a vehicle of the vehicle type, and (ii) a number of vehicles of the vehicle type that are available for transportation. The method further includes (c) providing a simulation environment for simulating loading of a vehicle. In addition, the method includes (d) selecting by an agent module a vehicle of a particular type, where: the selected vehicle has space available to accommodate at least a portion of the load; and the selection is based on a state of the environment, an observation of the environment, and a reward received previously from the environment; (e) receiving by the agent module a current reward from the environment in response to selecting the vehicle; and (f) repeating by the agent module steps (d) and (e) until the load is accommodated within space available in the one or more selected vehicles.

### FIELD

This disclosure generally relates to artificial intelligence (AI)/machine learning (ML) techniques and, in particular, to training and use of AI/ML modules to perform selection of vehicles and/or allocation of spaces for transporting and/or storing physical objects.

### BACKGROUND

A proper functioning of a society depends, in part, on ensuring that physical goods are made available to those who need them in a reliable, efficient manner. The goods can be of any type such as a carton of milk, items of clothing, consumer electronics, automobile parts, etc. Along their journey from the producers to the ultimate consumers, goods are stored in a number of places, such as at the storage facilities of the producers; warehouses of intermediaries, such as distributors and goods carriers; and at retail stores. Also, the goods are moved from one entity to another by loading them on to vans, trucks, train cars, airplanes, and/or ships.

Goods come in all kinds of shapes, sizes, and forms—some are fragile, some are bulky, some are heavy some need to be placed in an environment that is controlled for temperature, humidity, etc. Based on the size, shape, weight, and/or other characteristics of the goods, or based on the size, shape, and/or weights of enclosures (e.g., boxes, crates, etc.) in which the goods are placed, space needs to be allocated to different goods, both for storage, e.g., in a warehouse, and for transportation, e.g., on trucks, train cars, etc. Moreover, for transportation of goods, one or more vehicles needed to transport a particular load or shipment need to be selected based on not only the size, shape, and/or weight of the goods/enclosures, but also based on the types and numbers of vehicles that are available for transportation. For example, the shipper may choose several small trucks or a few large trucks, based on their availability.

In general the problem of allocating storage space for the storage of goods, whether on a vehicle or in a storage unit within a warehouse, is generally understood as computationally hard, due to practically infinite configurations that can be contemplated. The problem of selecting the right type(s) and number(s) of transportation vehicles is also generally understood to be computationally hard. As used herein, computationally hard means given a large enough problem, e.g., in terms of the number of enclosures, the number of different sizes of enclosures, number of different shapes of enclosures, number of different weights of enclosures, number of different vehicle types, and/or numbers of each type of vehicles that are available, a powerful computer having more than one processor or core may take excessively long (e.g., several hours, days, etc.) to find the best solution in terms of configuration of the enclosures in the storage space and/or the selection of vehicles for transportation. Alternatively, or in addition to taking excessively long, the computer may run out of memory.

In general the problem of allocating storage space for the storage of goods, whether on a vehicle or in a storage unit within a warehouse, does not admit polynomial time algorithms. In fact, many of them are NP-hard (non-deterministic polynomial-time hard) and, hence, finding a polynomial time solution is unlikely, due to practically infinite configurations that can be contemplated. For example, selecting the possible set of feasible solutions from the power set of all combinations may involve checking all combinations in terms of the number of enclosures, the number of different sizes of enclosures, number of different shapes of enclosures, number of different weights of enclosures, etc., and is likely to result in an enormous amount of computation which even the very powerful computers may take excessively long (e.g., several days, weeks, etc.) to solve. Alternatively or in addition to taking excessively long, the computer may run out of memory. The problem of selecting the right type(s) and number(s) of transportation vehicles only adds further to the complexity of the problem.

### SUMMARY

Methods and systems are disclosed using which a reinforcement learning (RL) module can learn to solve the vehicle selection and space allocation problems in an efficient manner, e.g., within a specified time constraint (such as, e.g., a few milliseconds, a fraction of a second, a few seconds, a few minutes, a fraction of an hour, etc.), and/or within a specified constraint on processing and/or memory resources. According to one embodiment, a method includes: (a) obtaining a specification of a load that includes enclosures of one or more enclosure types, and the specification includes, for each enclosure type: (i) dimensions of an enclosure of the enclosure type, and (ii) a number of enclosures of the enclosure type. The method also includes (b) obtaining a specification of vehicles of one or more vehicle types, where the specification includes, for each vehicle type: (i) dimensions of space available within a vehicle of the vehicle type, and (ii) a number of vehicles of the vehicle type that are available for transportation. The method further includes (c) providing a simulation environment for simulating loading of a vehicle. In addition, the method includes (d) selecting by an agent module a vehicle of a particular type, where: the selected vehicle has space available to accommodate at least a portion of the load; and the selection is based on a state of the environment, an observation of the environment, and a reward received previously from the environment; (e) receiving by the agent module a current reward from the environment in response to selecting the vehicle; and (f) repeating by the agent module steps (d) and (e) until the load is accommodated within space available in the one or more selected vehicles.

### BRIEF DESCRIPTION OF THE DRAWINGS

The present embodiments will become more apparent in view of the attached drawings and accompanying detailed description. The embodiments depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the present embodiments. In the drawings:

FIGS. 1A and 1B illustrate the vehicle selection and space allocation problems via one example;

FIG. 2 is a block diagram of a reinforcement learning (RL) system that can solve the vehicle selection and space allocation problems, according to various embodiments;

FIG. 3A is a plan view of the space available for loading inside a truck, according to one embodiment;

FIG. 3B is an elevation view of the space depicted in FIG. 3A, according to one embodiment;

FIG. 4A illustrates an exemplary co-ordinate space within a truck, according to one embodiment;

FIG. 4B illustrates reorientation of an enclosure that to be loaded within the co-ordinate space shown in FIG. 4A, according to one embodiment;

FIG. 5 is a flowchart illustrating a process according to one embodiment, that the RL system shown in FIG. 2 may execute, according to one embodiment; and

FIG. 6 depicts an exemplary artificial neural network (ANN) used to implement an agent in the RL system shown in FIG. 2, according to one embodiment.

### DETAILED DESCRIPTION

The following disclosure provides different embodiments, or examples, for implementing different features of the subject matter. Specific examples of components and arrangements are described below to simplify the present disclosure. These are merely examples and are not intended to be limiting.

The vehicle selection problem can be described as follows. Given a load defined by different numbers of enclosures (e.g., boxes, containers, crates, etc.) of different enclosure types and different numbers of vehicles of different vehicles types that are available, what is a set of optimized numbers of vehicles of different types that may be used to transport the load. The space allocation problem can be described as given a storage space defined by its dimensions, i.e. in terms of length, width, and height, what is an optimized configuration of the enclosures of the load so that the load can be stored within the given storage space. The optimized vehicle selection and space allocation strategy can lead to significant cost saving during operation.

Different enclosure types can be defined in terms of: (a) shapes, e.g., cubical, rectangular cuboid, cylindrical, etc.; (b) sizes, e.g., small, medium, large, very large, etc.; (c) weights, e.g., light, normal, heavy, very heavy, etc.; and (d) a combination of two or more of (a), (b), (c), In some cases, the enclosure types may also be defined in terms of other characteristics such as delicate or fragile, non-invertible, etc. Different vehicle types can be defined in terms of volumetric capacity and/or weight capacity. In some cases, vehicle types may be defined using additional characteristics such as environment controlled, impact resistant, heat resistant, etc. The storage space can be the storage space within a vehicle or the space allocated at a storage facility, such as a room or storage unit at a warehouse, a shelf, etc.

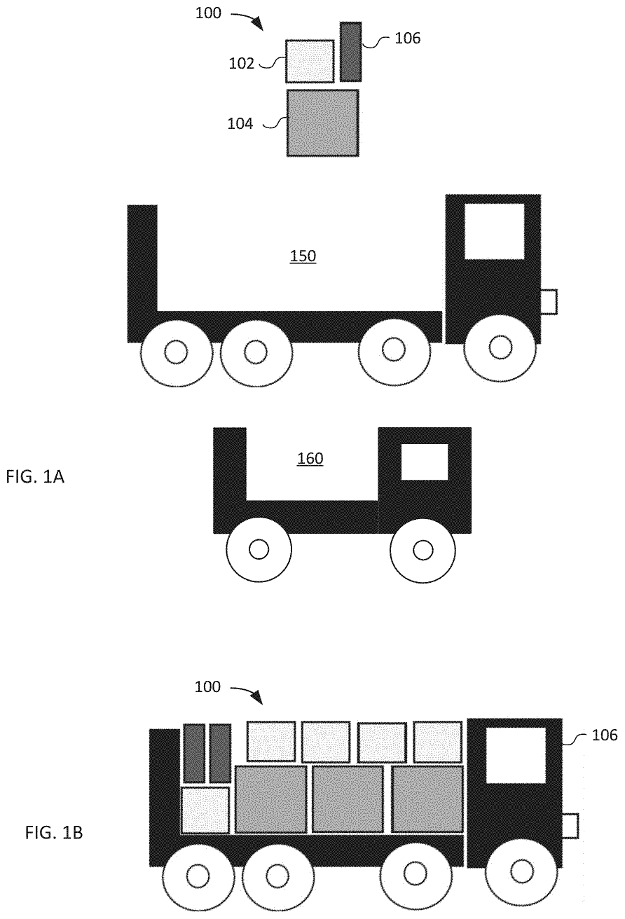

FIGS. 1A and 1B illustrate the vehicle selection and space allocation problems. The load 100 depicted in FIG. 1A includes boxes (enclosures, in general) of three different shapes and sizes. In particular, the load 100 includes three boxes 102 of type “A”; five boxes 104 of type “B”; and two boxes 106 of type “C.” Two different types of trucks, one large truck 150 and three small trucks 160 are available for transporting the load 100. In this example, the load 100 can fit within two small trucks 160, or within a single large truck 150. In one solution to the vehicle selection problem, the single large truck is selected. In another solution, two small trucks 160 may be selected. Upon selection of the large truck 150, the boxes are loaded according to the configuration shown in FIG. 1B so that all the boxes fit within the truck 150.

The example above is illustrative only, where solutions to both the vehicle selection and space allocation problems can be obtained in a straightforward manner. In general, however, for an arbitrary number of different types of enclosures, arbitrary numbers of enclosures of different types, an arbitrary number of vehicle types, and arbitrary numbers of vehicles of different types, the vehicle selection and/or space allocation problems can become unsolvable for a computing system, because the system run time generally increases exponentially with increases in the total number of variables in the problem to be solved or in the number of possible solutions that must be explored.

As such, for many vehicle-selection and/or loading problems, a typical computing system may run out of one or more of: (i) the allocated time for solving the problem, (ii) the allocated processing resources (e.g., in terms of allocated cores, allocated CPU time, etc.), or (iii) the allocated memory. In addition, the complexity of these problems can increase further if the available vehicles and/or storage spaces are partially filled with other loads, or if more than one loads are to be transported and/or stored.

Therefore, various embodiments described herein feature reinforcement learning (RL), where a machine-learning module explores different potential solutions to these two problems and during the exploration, learns to find a feasible and potentially optimized solution in an efficient manner i.e., without exceeding the processing and memory constraints. The learning is guided by a reward/penalty model, where the decisions by the RL module that may lead to a feasible/optimized solution are rewarded and the decisions that may lead to an infeasible or unoptimized solution are penalized or are rewarded less than other decisions.

In various embodiments discussed below, the vehicle selection solution considers the truck details and shipment details as environment observation ‘O1’ and, accordingly, constructs an action space at different states of the environment ‘E1’. The learning agent ‘A1’ of the methodology tries to learn the policy for choosing a truck. The agent ‘A1’ interacts with the environment and interprets observation ‘O1’ to take an action. The Environment ‘E1’, in turn, returns a reward associated with the action, and the environment transitions to a new state.

In various embodiments, the space allocation solution considers the left-over (i.e., yet to be loaded) enclosures and volume left in selected vehicle as environment observation ‘02’ and, accordingly, constructs an action space at different states of the environment ‘E2’. The learning agent ‘A2’ of the methodology tries to learn the policy for placing enclosures in the vehicle. The agent ‘A2’ interacts with the environment and interprets observation ‘O2’ to take an action. The environment ‘E2’, in turn, returns a reward associated with the action, and transitions to a new state.

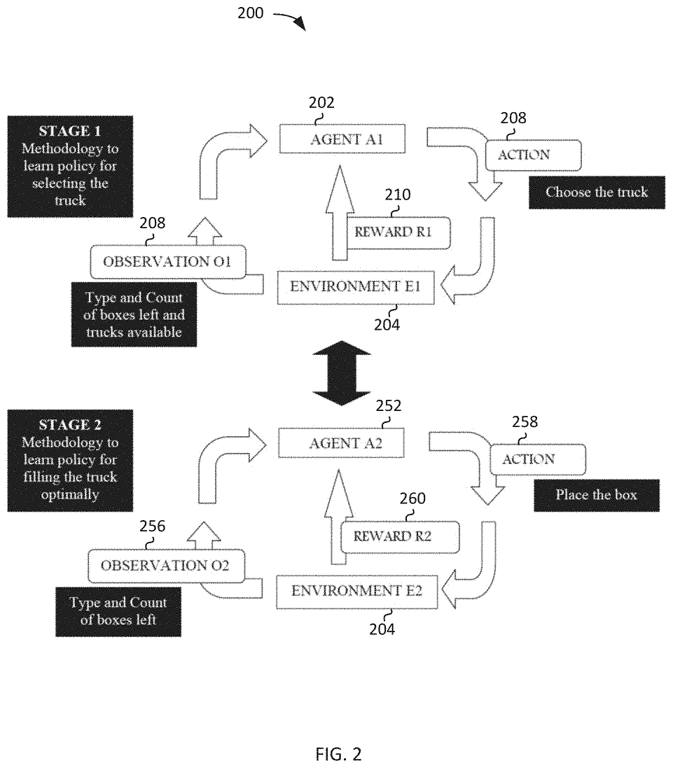

FIG. 2 is a block diagram of a reinforcement learning (RL) system 200 that can solve the vehicle selection and space allocation problems. The system 200 includes an agent A1 202 and an environment E1 204. The agent A1 202 leverages an approach such as an artificial neural network (ANN) or a Q-learning system for learning the optimized strategy for vehicle selection. The Agent A1 202 makes an observation O1 206 about the state of environment E1 204

Based on the observation O1 206, the agent A1 202 performs an action 208 to change the state of the environment E1 204. In response to the action 208, the environment E1 204 provides a reward R1 210 to the agent A1 202. The state of the environment E1 204 changes and/or new observation O1 206 may be made. According to the new observation, the agent A1 202 takes another action 208, and obtains a new reward R1 210. This iterative process may continue until the agent A1 202 learns a policy and finds a solution to the vehicle selection problem.

The system 200 also includes another agent A2 252 and another environment E2 254. The agent A2 252 uses an approach such as an ANN or a Q-learning system for learning the optimized strategy for space allocation. The Agent A2 252 makes an observation O2 256 about the state of environment E2 254. Based on the observation O2 256, the agent A2 252 performs an action 258 to change the state of the environment E2 254. In response to action 258, the environment E2 254 provides a reward R2 260 to the agent A2 252, and the state of the environment E2 254 changes and/or new observation O2 256 may be made. According to the new observation, and based on the received reward R2 260, the agent A2 252 takes another action 258. This iterative process may continue until the agent A1 252 learns a policy and finds a solution to the space allocation problem.

In some embodiments, the system 200 includes only the agent A1 202 and the environment E1 204 and the associated observations O1 206, actions 208, and rewards R1 210. In these embodiments the system 200 is configured to solve the vehicle selection problem only. In some other embodiments, the system 200 includes only the agent A2 252 and the environment E2 254 and the associated observations O2 256, actions 258, and rewards R2 260. As such, in these embodiments the system 200 is configured to solve the space allocation problem only. The space in which the goods are to be placed can be but need not be the space within a vehicle. Instead, the space can be a space in a warehouse, such as a room, a storage unit, or a rack; space in a retail store, such as a rack or a shelf, etc.

In embodiments in which the system 200 includes both agents A1 202 and A2 252 and the other associated components, the system can solve the vehicle selection problem in Stage 1 and the space allocation problem in Stage 2. In some cases, the two stages do not overlap, i.e., the vehicle selection problem is solved first in Stage 1 to select one or more vehicles of one or more vehicle types. Thereafter, the space allocation problem is solved in Stage 2, where the space in which the goods are to be stored is the space within the selected vehicle(s).

In some cases, the two stages may overlap. For example, after completing one or more but not all of the iterations of the vehicle selection problem, a candidate set of vehicles is obtained and is used to solve, in part but not entirely, the space allocation problem. The system 200 may be configured to alternate between solving, in part, the vehicle selection problem and solving, in part, the space allocation problem, until optimized solutions to both problems may be found simultaneously.

In Stage 1, the vehicle and load (also called shipment) details are considered as observations O1 206 from the environment E1 204. Vehicle details include the types of different vehicles that are available for transporting the load or a portion thereof. For example, for road transportation, the vehicles may include vans, pick-up trucks, medium-sized trucks, and large tractor-trailers. The different types of vehicles may be described in terms of their volumetric capacity and/or weight capacity. In addition, observations O1 206 about the vehicles may also include the numbers of different types of vehicles that are available at the time of shipment. For example, on a certain day or at a certain time five vans, two pick-up trucks, no medium-sized trucks, and one tractor-trailer may be available, while on another day or at a different time, two vans, two pick-up trucks, two medium-sized trucks, and one tractor trailer may be available.

Load details include different types of load items or enclosures and the respective numbers of different types of enclosures. An enclosure type may be defined in terms of its size (e.g., small, medium, large, very large, etc.); shape (e.g., cubical, rectangular cuboid, cylindrical, etc.); and/or weight, e.g., light, normal, heavy, very heavy, etc. A load item type/enclosure type may also be described in terms of a combination of two or more of size, shape, and weight. In some cases, the enclosure types may also be defined in terms of other characteristics such as fragile, perishable (requiring a refrigerated storage/transportation), non-invertible, etc.

Based on the observations O1 206, the agent A1 202 constructs a set of actions 208 for different states of the environment E1 204. For example, if the cumulative size and/or the total weight of the load are greater than the size weight capacity of a particular type of vehicle, one candidate action is to select two or more vehicles of that type, if such additional vehicles are available. Another candidate action is to choose a different type of vehicle. Yet another action is to use a combination of two different types of vehicles. In general, the learning agent A1 202 attempts to learn a policy for choosing one or more vehicles for shipping the load based on the observations O1 206, the states of the environment E1 204, the actions 208, and the rewards R1 210.

To this end, the agent A1 202 interacts with the environment E1 204 and interprets an observation O1 206 and the current state of the environment E1 204, to take an action 208 selected from the constructed set of actions. The environment E1 204, in turn, returns a reward 210 associated with the action, and transitions to a new state. Table 1 shows the details of these parameters.

TABLE 1
Parameters for the Vehicle-Selection Problem

| Term | Description |
|---|---|
| Observation | Number(s) and type(s) of enclosures that |
| | remain to be loaded on to one or more vehicles |
| State | Number(s) and type(s) of available vehicles |
| Action | Selection of an available vehicle |
| Reward | Derived from the cost of the selected vehicle |

As the table above shows, the reward is derived from the cost of a vehicle. In some embodiments, the reward is the negative cost of a vehicle. The reward can be derived using various other factors, in different embodiments. As such, the system 200 rewards the agent A1 202 for selecting less costly vehicles, e.g., vehicles that may be smaller, that may be less in demand, etc. As part of exploration during RL, the system 200 does not mandate, however, that only the least costly vehicle be selected every time. Rather, the selection of such a vehicle is merely favored over the selection of other vehicles.

During iterations of the observation-action-reward cycle (also referred to as episodes) that the system 200 performs in Stage 1, the agent A1 202 takes into account the number(s) and type(s) of enclosures that remain to be loaded on to one or more vehicles, and the number(s) and type(s) of available vehicles. Using this information, the agent A1 202 takes an action 208, i.e., selects an available vehicle. When a new vehicle is selected, it results in a state change of environment E1 204 because the selected vehicle is no longer available. The observations O1 206 also changes because one or more vehicle are not available for selection. The iterations are typically terminated when a solution is found, i.e., the entire load is loaded on to one or more vehicles. In some cases, the agent A1 202 may determine that no feasible solution can be found. In general, the agent A1 202 attempts to maximize the cumulative reward, so that the overall cost of the vehicles selected for the shipment of the load is minimized, while satisfying the size and weight constraints of each selected vehicle.

In Stage 2, the observations O2 256 from the environment E2 254 include the space available within a selected vehicle and the load/shipment details. The space that is available within a selected vehicle may be described in terms of length, width, and height. The selected vehicle may be partially filled and, as such, the available space may be less than the space available in the selected vehicle when it is empty. Also, the available space may not be a single volume; rather, it can be defined by two or more volumes of different lengths, widths, and/or heights. The different volumes may be contiguous or discontiguous. In addition to the volumetric parameters, i.e., length, width, and height, the available space may also be defined in terms of the weight capacity thereof. The load details, in general, are the same as those observed in Stage 1.

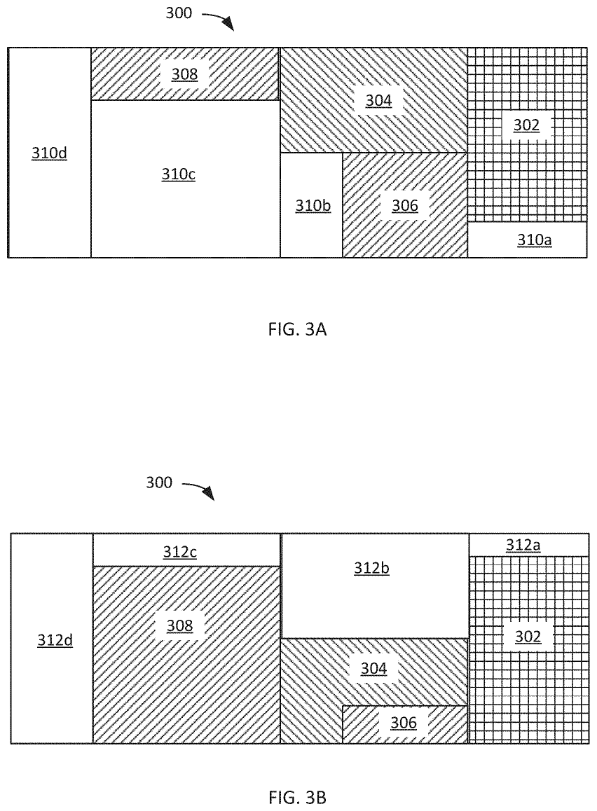

FIGS. 3A and 3B illustrate an example of the space available for loading goods. In particular, FIG. 3A is a plan view of a space 300 inside a truck, where the shaded regions 302-308 indicate portions of the space 300 that are already occupied. The unshaded region 310 represents the available space. The available space can be defined, in part, in terms of the respective lengths and widths of the rectangles 310a-310d. The space defined by the rectangle 310a, though available, may be inaccessible. Although the regions 302-308 represent unavailable floor space in the selected vehicle, space may be available on top of one or more of the items stored in the spaces 302-308. This is illustrated in FIG. 3B, which is an elevation view of the space 300. In particular, small spaces 312a and 312c are available on top of the goods/enclosures stored in the spaces 302 and 308. Relatively more space 312b is available on top of the goods/enclosures stored in the space 304 and even more space (not shown) is available on top of the goods/enclosures stored in the space 306. The space defined by the rectangle 310d in FIG. 3A and by the corresponding rectangle 312d in FIG. 33 is entirely available.

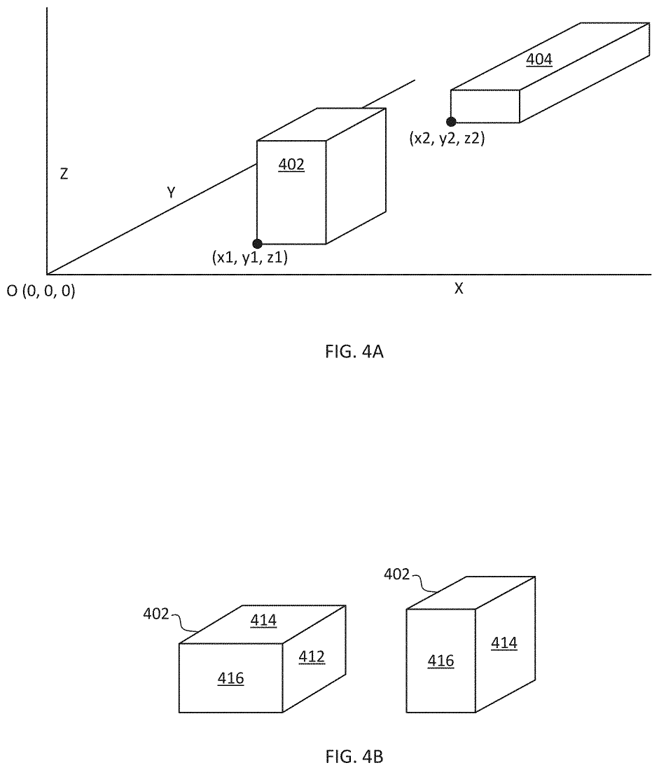

Referring again to FIG. 2, based on the observations O2 256, the agent A2 252 constructs a set of actions 258 for different states of the environment E2 254. In general, the candidate actions include selecting three-dimensional co-ordinates (X, Y, Z) within the space that is available within the selected vehicle, where a good/enclosure may be placed. Candidate actions may also include changing the orientation of the good/enclosure, e.g., a rotation in the X-Y plane, a rotation in the X-Z plane, or a rotation in the Y-Z plane. FIG. 4A illustrates an exemplary co-ordinate space within a truck. The origin, denoted O(0, 0, 0), may be aligned with one of the corners of the storage space of the truck. An enclosure 402 is stored at the location (x1, y1, z1). In this example, the enclosure 402 is stored on the floor of the storage space of the truck and, as such, z1=0. Another enclosure 404 is stored at the location (x2, y2, z2). The enclosure 404 is stored on top of another item (not shown) and, as such, z2 is not equal to zero.

FIG. 4B illustrates reorientation of the enclosure 402. Initially the enclosure 402 may be placed such that the surface 412 is on the right side, the surface 414 is on the top, and the surface 416 is in the front. It may not be feasible to place the enclosure 402 at the location (x1, y1, z1) in this orientation, e.g., due to shape of the space available at that location. Therefore, the enclosure is reoriented, by flipping it on the side surface 412, where the surface 414 becomes the new side surface. The surface 416 remains the front surface. In this new orientation, it may be feasible to place the enclosure in the space available at (x1, y1, z1). In some cases, an enclosure may be reoriented so as to improve the usage of the overall available space. Referring again to FIG. 2, the agent A2 252 may perform the reorientation action, even when it is feasible to place the enclosure at the selected location without such orientation, if the reward from the reorientation and placement is greater than the reward for the placement without reorientation.

In general, the learning agent A2 252 attempts to learn a policy for choosing one or more locations defined by the co-ordinates (x, y, z) where one or more enclosures may be placed, and by choosing one or more orientations of the enclosures to be placed prior to their placement, based on the observations O2 256, the states of the environment E2 254 the actions 258, and the rewards R2 260. To this end, the agent A2 252 interacts with the environment E2 254 and interprets an observation O2 256 and the current state of the environment E2 254 to take an action 258 selected from the set of constructed actions. The environment E2 254, in turn, returns a reward R2 260 associated with the action 258, and transitions to a new state. Table 2 shows the details of these parameters.

TABLE 2
Parameters for the Space Allocation Problem

| Term | Description |
|---|---|
| Observation | Type(s) of enclosures remaining to be loaded |
| | and count(s) of enclosures remaining to be |
| | loaded of each type |
| State | Current filled state of the vehicle and available |
| | empty spaces in the vehicle |
| Action | All the possible locations within the vehicle at |
| | which the next enclosure may be placed, and |
| | the different orientations of the enclosure |
| Reward | Derived from the volume and/or weight change |
| | resulting from placing an enclosure in a vehicle |

Since the reward is derived from the volume and/or weight change, the system 200 rewards the agent A2 252 for selecting and placing bulkier and/or heavier enclosures more than it reward the agent A2 for selecting relatively smaller and or lighter enclosures. As part of exploration during RL, however, the system 200 does not mandate that only the largest and/or heaviest enclosures be selected and placed first. Rather, the selection of such enclosures is merely favored over the selection of other enclosures.

During iterations of the observation-action-reward cycle (also called episodes) that the system 200 performs in Stage 2, the agent A2 252 takes into account the number(s) and type(s) of enclosures that remain to be loaded on to the selected vehicle, and the dimensions and size(s) of the space(s) available in the selected vehicle. Using this information, the agent A2 252 takes an action 258, i.e., selects an available space within the selected vehicle, selects an enclosure for placement, and selects an orientation for the enclosure. Upon making these selections, state of the environment E2 254 changes because a part of the previously available space is no longer available. The observations O2 256 also change because one or more enclosures from the load no longer needs to be loaded.

The iterations are typically terminated when a solution is found, i.e., the entire load is loaded on to the selected vehicle. In some cases, where more than one vehicles are selected, only a portion of the entire load is designated to be loaded on to a particular vehicle. In that case, the iterations may be terminated when the designated portion of the load is loaded on to one selected vehicle. Iterations described above may then commence to load another designated portion of the entire load on to another one of the selected vehicles. This overall process may continue until the entire load is distributed across and loaded on to the selected vehicles. In some cases, the agent A2 252 may determine, however, that no feasible solution can be found.

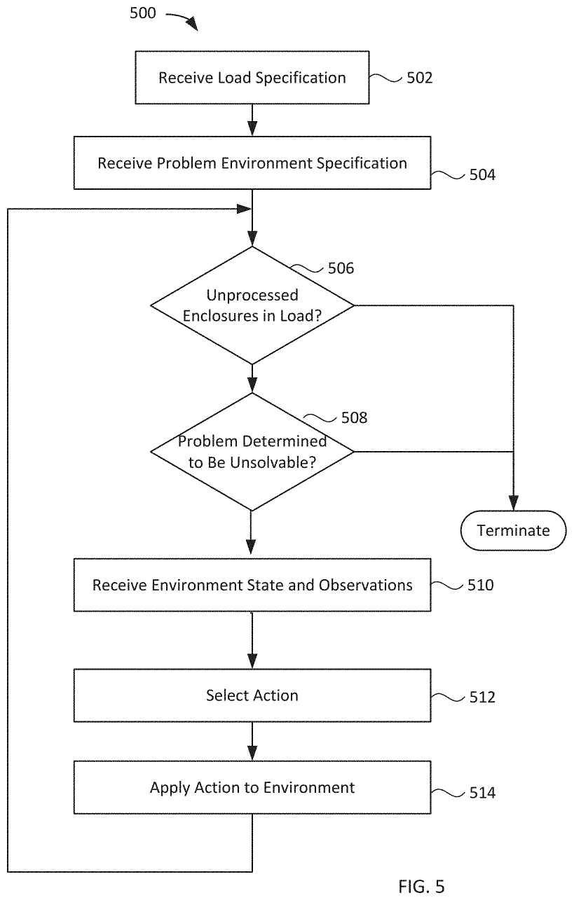

FIG. 5 is a flowchart illustrating a process 500 that the agent A1 202 or the agent A2 252 (FIG. 2) may execute. In step 502, a specification of a load is received. The specification describes the types of the enclosures in the load and the numbers of different types of enclosures. Each type of enclosure may be specified by its size, dimensions (e.g., length, width, and height), and/or weight. Any additional constraints, such as fragile, the side on which the enclosure must be placed, etc., may also be specified.

In step 504, depending on the problem to be solved i.e., the vehicle selection problem or the space allocation problem, a specification of the corresponding environment i.e., the environment E1 204 or the environment E2 254 (FIG. 2) is received. For the environment E1 204, the specification includes the types of vehicles and numbers of different types of vehicles that are available for transportation. The specification also includes, for each type of vehicle, the dimensions of the space available within that type of vehicle for storing goods/enclosures and weight limits. Additional constraints, such as the routes the vehicles of a particular type may not take, overall demand for the vehicles of a particular type etc., may also be specified. For the environment E2 254, the specification includes, for each vehicle that is to be loaded, the information that is described above but specific to that particular vehicle.

In step 506, a determination is made if any enclosures in the load remain to be processed. If not, the process terminates. If one or more enclosures remain to be processed, step 508 tests whether it has been determined that a feasible solution cannot be found. If such a determination is made, the process terminates. Otherwise, in step 510, the state of the environment (E1 204 or E2 254 (FIG. 2)) and corresponding observations (O1 206 or O2 256 (FIG. 2)) are obtained. Using the state and observations, and a received reward, (as discussed below), an action (208 or 258 (FIG. 2)) is selected in step 512. In step 514, the selected action is applied to the environment (E1 204 or E2 254 (FIG. 2)). In other words, the environment is simulated to undertake the selected action. In response, the environment provides a reward (R1 210 or R2 260 (FIG. 2)), and the state of the environment changes. The process then returns to the step 506. The observations, states, actions, and rewards are shown in Tables 1 and 2 above. When all the enclosures in the load are processed, an optimized solution to the problem to be solved is found.

In various embodiments, the agent A1 202 or the agent A2 252 may learn the optimal policy using approaches such as the Q-learning model or an artificial neural network (ANN). In a Q-learning model, the agent employs a policy (denoted π), e.g., a strategy, to determine an action (denoted a) to be taken based on the current state (denoted s) of the environment. In general in RL, an action that may yield the highest reward (where a reward is denoted r) may be chosen. The Q-model, however, takes into account a quality value, denoted Q (s, a), that represents the long-term return of taking a certain action a, determined based on the chosen policy π, from the current state s. Thus, the Q-model accounts for not only the immediate reward of taking a particular action, but also the long-term consequences and benefits of taking that action. The expected rewards of future actions, as represented by the future expected states and expected actions are typically discounted using a discount factor, denoted γ. The discount factor γ is selected from the range [0, 1], so that future expected values are weighed less than the value of the current state.

The policy used in a Q-learning model can be ε-greedy, ε-soft, softmax, or a combination thereof. According to the ε-greedy policy, generally the greediest action, i.e., the action with the highest estimated reward, is chosen. With a small probability c, however, an action is selected at random. The reason is, an action that does not yield the most reward in the current state can nevertheless lead to a solution for which the cumulative reward is maximized, leading to an overall optimized solution. The ε-soft policy is similar to the c-greedy, but here each action is taken with a probability of at least ε. In these policies, when an action is selected at random, the selection is done uniformly. In softmax, on the other hand, a rank or a weight is assigned to each action, e.g., based on the action-value estimates. Actions are then chosen according to probabilities that correspond to their rank or weight.

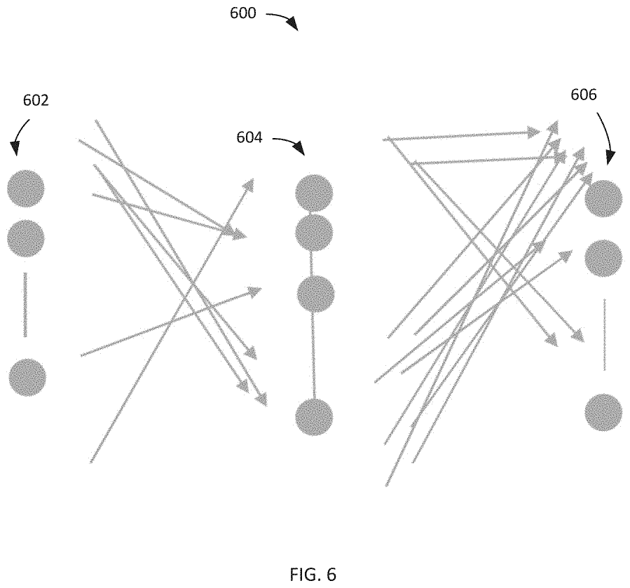

The agent A1 202 and/or the agent A2 252 can also learn the optimal policy using an artificial neural network (ANN) model. FIG. 6 depicts an exemplary ANN 600. Neural networks, in general can be considered to be function approximators. Therefore, an ANN can be used to approximate a value function or an action-value function that assists in choosing actions. In other words an ANN can learn to map states of an environment (e.g., the environments E1 204, E2 254 shown in FIG. 2) to Q-values and thus to actions. Thus, the ANN 600 can be trained on samples from the set of states of the environments E1 204, E2 254 (FIG. 2) and/or the set of actions 206, 256 (FIG. 2) to learn to predict how valuable those actions are.

In some embodiments, the ANN 600 is a convolutional network. A conventional convolutional network can be used to perform classification, e.g., classifying an input image as a human or an inanimate object (e.g., a car), distinguishing one type of vehicle from other types of vehicles, etc. Unlike the conventional convolution networks, however, the ANN 600 does not perform classification. Rather the input layer 602 of the ANN 600 receives the state of the environment for which it is trained. The state is then recognized from an encoded representation thereof in a hidden layer 604. Based on the recognized state, in the output layer 606 the candidate actions that are feasible in that state are ranked. The ranking is based on the respective probability values of the state and the respective candidate actions. Examples of such actions are described in Tables 1 and 2 above.

In summary, techniques are described herein to find optimized solutions to the vehicle selection and space allocation problems. These solutions can reduce or minimize the cost of vehicle on-loading and transportation in a supply chain. In particular, various techniques described herein facilitate a methodological selection of vehicles and on-loading of the selected vehicles, i.e., placement of the goods/enclosures to be transported within the space available within the selected vehicles. To this end, a framework of policy-based reinforcement learning (RL) is used where a model is trained through trial and error, and through actions that result in a high positive reward. The rewards are modelled so as to minimize the cost of storage and/or transportation. Furthermore, another RL model is trained to improve utilization of the available space(s) in the selected vehicles and to reduce or minimize waste of the available space.

The RL can take into constraints about the use of the vehicles and/or the load. For example, certain large vehicles, though available, may not be permitted in certain neighborhoods. Likewise, it may be impermissible or undesirable to change the orientation of certain enclosures or to keep other enclosures on top of certain enclosures. In the RL-based techniques described herein, an intelligent agent can select from possible actions to be taken, where such actions are associated with respective rewards.

In various embodiments, the RL-based techniques described above provide several benefits. For instance, some of the previously proposed solutions do not account for different types of vehicles and/or different numbers of vehicles of different types that may be available. Embodiments of the system 200 (FIG. 2) described above consider both of these parameters as variables, making the system 200 useful in a wide range of real-world challenges related to the selection and loading of vehicles for the transportation of goods. In addition, many previously proposed techniques do not address the actual loading of the selected vehicles. Several embodiments of the system 200 can address the space allocation problem, as well. Moreover, some previous techniques that attempt to solve the space allocation problem often assume that all the items to be placed are of the same shape and size. Various embodiments of the system 200 do not impose this restriction, i.e., the enclosures (such as boxes, crates, pallets, etc.) that are to be placed can be of different sizes, shapes, and/or weights.

Some embodiments of the system 200 can take into account additional constraints, such as some vehicles, though available, may be unsuitable or undesirable for use along the route of a particular shipment. To accommodate this constraint, the cost of such vehicles, which is used to determine the reward, can be customized according to the shipment route. The optimized vehicle selection and optimized space allocation during on-loading of the selected vehicles can reduce the overall shipment costs and/or time, e.g., by reducing the distances the vehicles must travel empty and/or by improving coordination between vehicle fleets and loaders, and by avoiding or mitigating trial-and-error and waste of available space during the on-loading process. The solution to the space allocation problem is not limited to the on-loading of transportation vehicles only and can be applied in other contexts, e.g., for optimizing the use of shelf space in retail, palette loading in manufacturing, etc.

Having now fully set forth the preferred embodiment and certain modifications of the concept underlying the present invention, various other embodiments as well as certain variations and modifications of the embodiments herein shown and described will occur to those skilled in the art upon becoming familiar with said underlying concept.

What is claimed is:

1. A method for selecting one or more vehicles for transporting goods, the method comprising:
(a) obtaining a specification of a load comprising enclosures of one or more enclosure types, the specification comprising, for each enclosure type: (i) dimensions of an enclosure of the enclosure type, and (ii) a number of enclosures of the enclosure type;
(b) obtaining a specification of vehicles of one or more vehicle types, the specification comprising, for each vehicle type: (i) dimensions of space available within a vehicle of the vehicle type, and (ii) a number of vehicles of the vehicle type that are available for transportation;
(c) providing a simulation environment for simulating loading of a vehicle;
(d) selecting by an agent module a vehicle of a particular type, wherein:
the selected vehicle has space available to accommodate at least a portion of the load; and
the selection is based on a state of the environment, an observation of the environment, and a reward received previously from the environment;
(e) receiving by the agent module a current reward from the environment in response to selecting the vehicle; and
(f) repeating by the agent module steps (d) and (e) until the load is accommodated within space available in the one or more selected vehicles.

2. The method of claim 1, wherein the specification of the load comprises one or more of:
a weight of a particular enclosure from the load; or
a constraint on an orientation of the particular enclosure.

3. The method of claim 1, wherein the specification of vehicles comprises one or more of:
a weight capacity of a particular vehicle; or
a constraint on routes taken by the particular vehicle.

4. The method of claim 1, wherein:
the state comprises one or more types of vehicles available and respective numbers of vehicles that are available of each type;
the observation comprises one or more types of enclosures that remain to be loaded on to one or more vehicles, and respective numbers of enclosures of each such type; and
the reward is derived from cost of the selected vehicle.

5. The method of claim 1, wherein the agent comprises a Q-learning module or an artificial neural network (ANN).

6. A method for on-loading a vehicle for transporting goods, the method comprising:
(a) obtaining a specification of a load comprising enclosures of one or more enclosure types, the specification comprising, for each enclosure type: (i) dimensions of an enclosure of the enclosure type, and (ii) a number of enclosures of the enclosure type;
(b) obtaining a vehicle specification comprising a set of dimensions representing one or more spaces within the vehicle that are available for on-loading;
(c) providing a simulation environment for simulating loading of the vehicle;
(d) selecting by an agent module a location within the one more spaces for placement of an enclosure chosen from the load for placement, wherein the selection of the location is based on a state of the environment, an observation of the environment, a reward received previously from the environment, and dimensions of the chosen enclosure;
(e) receiving by the agent module a current reward from the environment in response to selecting the location for the placement of the chosen enclosure; and
(f) repeating by the agent module steps (d) and (e) until the load is accommodated within the one or more spaces available within the vehicle.

7. The method of claim 6, wherein the specification of the load comprises one or more of:
a weight of a particular enclosure from the load; or
a constraint on an orientation of the particular enclosure.

8. The method of claim 6, wherein the vehicle specification comprises one or more of:
a weight capacity of the vehicle; or
a constraint on routes taken by the vehicle.

9. The method of claim 6, further comprising:
selecting by the agent module a new orientation of the chosen enclosure.

10. The method of claim 6, wherein:
the state comprises an identification of one or more spaces within the vehicle that are occupied;
the observation comprises one or more types of enclosures that remain to be loaded on to the vehicle, and respective numbers of enclosures of each such type; and
the reward is derived from a change in volume of the one or more spaces within the vehicle that are available for on-loading resulting from placement of the chosen enclosure within the one or more spaces.

11. The method of claim 6, wherein the reward is derived from a change in weigh of the vehicle resulting from placement of the chosen enclosure within the one or more spaces within the vehicle that are available for on-loading.

12. The method of claim 6, wherein the agent comprises a a-learning module or an artificial neural network (ANN).

13. A system for selecting one or more vehicles for transporting goods, the system comprising:
a processor; and
a memory in communication with the processor and comprising instructions which, when executed by the processor, program the processor to:
(a) obtain a specification of a load comprising enclosures of one or more enclosure types, the specification comprising, for each enclosure type: (i) dimensions of an enclosure of the enclosure type, and (ii) a number of enclosures of the enclosure type;
(b) obtain a specification of vehicles of one or more vehicle types, the specification comprising, for each vehicle type: (i) dimensions of space available within a vehicle of the vehicle type, and (ii) a number of vehicles of the vehicle type that are available for transportation;
(c) provide a simulation environment for simulating loading of a vehicle; and
(d) operate as an agent module, wherein the instructions program the agent module to:
(A) select a vehicle of a particular type, wherein: (i) the selected vehicle has space available to accommodate at least a portion of the load; and (ii) the selection is based on a state of the environment, an observation of the environment and a reward received previously from the environment;
(B) receive a current reward from the environment in response to selecting the vehicle; and
(C) repeat operations (d)(A) and (d)(B) until the load is accommodated within space available in the one or more selected vehicles.

14. The system of claim 13, wherein the specification of the load comprises one or more of:
a weight of a particular enclosure from the load; or
a constraint on an orientation of the particular enclosure.

15. The system of claim 13, wherein the specification of vehicles comprises one or more of:
a weight capacity of a particular vehicle; or
a constraint on routes taken by the particular vehicle.

16. The system of claim 13, wherein:
the state comprises one or more types of vehicles available and respective numbers of vehicles that are available of each type;
the observation comprises one or more types of enclosures that remain to be loaded on to one or more vehicles, and respective numbers of enclosures of each such type; and
the reward is derived from cost of the selected vehicle.

17. The system of claim 13, wherein the agent comprises a Q-learning module or an artificial neural network (ANN).

18. A system for on-loading a vehicle for transporting goods, the system comprising:
a processor; and
a memory in communication with the processor and comprising instructions which, when executed by the processor, program the processor to:
(a) obtain a specification of a load comprising enclosures of one or more enclosure types, the specification comprising, for each enclosure type: (i) dimensions of an enclosure of the enclosure type, and (ii) a number of enclosures of the enclosure type;
(b) obtain a vehicle specification comprising a set of dimensions representing one or more spaces within the vehicle that are available for on-loading;
(c) provide a simulation environment for simulating loading of the vehicle; and
(d) operate as an agent module, wherein the instructions program the agent module to:
(A) select a location within the one more spaces for placement of an enclosure chosen from the load for placement, wherein the selection of the location is based on a state of the environment, an observation of the environment, a reward received previously from the environment, and dimensions of the chosen enclosure;
(B) receive a current reward from the environment in response to selecting the location for the placement of the chosen enclosure; and
(C) repeat by operations (d)(A) and (d)(B) until the load is accommodated within the one or more spaces available within the vehicle.

19. The system of claim 18, wherein the specification of the load comprises one or more of:
a weight of a particular enclosure from the load; or
a constraint on an orientation of the particular enclosure.

20. The system of claim 18, wherein the vehicle specification comprises one or more of:
a weight capacity of the vehicle; or
a constraint on routes taken by the vehicle.

21. The system of claim 18, wherein the instructions program the agent module to select a new orientation of the chosen enclosure.

22. The system of claim 18, wherein:
the state comprises an identification of one or more spaces within the vehicle that are occupied;
the observation comprises one or more types of enclosures that remain to be loaded on to the vehicle, and respective numbers of enclosures of each such type; and
the reward is derived from a change in volume of the one or more spaces within the vehicle that are available for on-loading resulting from placement of the chosen enclosure within the one or more spaces.

23. The system of claim 18, wherein the reward is derived from a change in weigh of the vehicle resulting from placement of the chosen enclosure within the one or more spaces within the vehicle that are available for on-loading.

24. The system of claim 18, wherein the agent comprises a Q-learning module or an artificial neural network (ANN).
